(19) United States
(12) Patent Application Publication
(10) Pub. No.: US 2014/0153561 A1
(43) Pub. Date: Jun. 5, 2014

(54) NETWORK TESTING SYSTEM AND OPERATING METHOD THEREOF

(71) Applicant: Electronics and Telecommunications Research Institute, Daejeon (KR)

(72) Inventors: Jong Kuk LEE, Daejeon (KR); Youn Seo JEONG, Daejeon (KR); Ki Dong NAM, Daejeon (KR)

(73) Assignee: Electronics and Telecommunications Research Institute, Daejeon (KR)

(21) Appl. No.: 13/954,026

(22) Filed: Jul. 30, 2013

(30) Foreign Application Priority Data
Dec. 5, 2012 (KR) 10-2012-0140367

(51) Int. Cl. H04W 56/00

(52) U.S. Cl. CPC H04W 56/0015
USPC 370/350

(57) ABSTRACT

A network testing system according to an exemplary embodiment of the present invention includes: a radio wave transmitting apparatus which transmits a standard wave including timing data; a first network testing apparatus which performs time synchronization based on the timing data at the time of receiving the standard wave and generates first timing information; and a second network testing apparatus which performs time synchronization based on the timing data at the time of receiving the standard wave, generates second timing information, and transmits a network test reply and the second timing information for network testing at the time of receiving a network test request and the first timing information from the first network testing apparatus to perform the network testing along with the first network testing apparatus.

### CROSS-REFERENCE TO RELATED APPLICATIONS

This application claims priority to and the benefit of Korean Patent Application No. 10-2012-0140367 filed in the Korean Intellectual Property Office on Dec. 5, 2012, the entire contents of which are incorporated herein by reference.

### TECHNICAL FIELD

The present invention relates to a network testing system and an operating method thereof, and more particularly, to a network testing system using a standard wave to facilitate time synchronization with at least two network testing apparatuses and an operating method thereof.

### BACKGROUND ART

When a general network testing apparatus (packet generator & analyzer) performs network testing along with another network testing apparatus that is at a long distance therefrom, time synchronization between two different network testing apparatuses uses a network time protocol (NTP) or a geographic position system (GPS).

For using GPS with less timing error, an expensive GPS antenna needs to be installed outside the door and since the NTP performs the time synchronization through the network, the network itself causes a time delay and the error in the time delay of the network occurs, such that the NTP has not been used to measure a high speed network.

### SUMMARY OF THE INVENTION

The present invention has been made in an effort to provide a network testing system using a standard wave to facilitate time synchronization with at least two network testing apparatuses, and an operating method thereof.

An exemplary embodiment of the present invention provides a network testing system, including: a radio wave transmitting apparatus which transmits a standard wave including timing data; a first network testing apparatus which performs time synchronization based on the timing data at the time of receiving the standard wave and generates first timing information; and a second network testing apparatus which performs time synchronization based on the timing data at the time of receiving the standard wave, generates second timing information, and transmits a network test reply and the second timing information for network testing at the time of receiving a network test request and the first timing information from the first network testing apparatus to perform the network testing along with the first network testing apparatus.

Another exemplary embodiment of the present invention provides an operating method of a network testing system, including: performing time synchronization based on time data and generating first timing information by a first network testing apparatus at the time of transmitting a standard wave including the timing data from a radio wave transmitting apparatus; transmitting the first timing information and a network test request to a second network testing apparatus; determining whether the time synchronization of the second network testing apparatus is performed, based on at least one of a network test reply and second timing information, at the time of receiving the network test reply and the second timing information corresponding to the network test request and the first timing information from the second network testing apparatus; and as the determination result, when the timing synchronization of the second network testing apparatus is completed, performing the network testing along with the second network testing apparatus.

According to the exemplary embodiments of the present invention, the network testing system and the operating method thereof can receive the standard signal to perform the time synchronization based on timing data included in the standard signal, thereby remarkably reducing the timing error.

According to the exemplary embodiments of the present invention, the network testing system and the operating method thereof can perform the time delay test, the jitter test, the VoIP and IPTV quality tests, and the like, between different network testing apparatuses at a remote place by using the timing information with the very small error.

According to the exemplary embodiments of the present invention, the network testing system and the operating method thereof can be implemented by a small and inexpensive radio wave receiving unit receiving the standard signal, for example, a radio wave receiver, and the like.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a system diagram illustrating a network testing system according to an exemplary embodiment of the present invention.

FIG. 2 is a control block diagram illustrating a control configuration of the network testing system illustrated in FIG. 1.

FIG. 3 is a flow chart illustrating an operating method of a network testing system according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

In describing components of exemplary embodiments of the present invention, components with the same name may be denoted by different reference numbers throughout the drawings and different drawings may be denoted by the same reference numerals. However, even in this case, it does not mean that the corresponding components have different functions according to the exemplary embodiments of the present invention or have the same functions in different embodiments and function of each component will be determined based on the description of each component in the corresponding embodiments of the present invention.

In describing the exemplary embodiments, well-known functions or constructions will not be described in detail since they may unnecessarily obscure the understanding of the present invention.

In describing components of exemplary components, terms such as first, second, A, B, (a), (b), etc., can be used. These terms are used only to differentiate the components from other components. Therefore, the nature, order, sequence, etc., of the corresponding components are not limited by these terms. When any component is “connected”, “coupled”, or “linked” to other components, it should be understood that the components may be directly connected or linked to other components, but the components may be “connected”, “coupled”, or “linked” to other components via another component therebetween.

Hereinafter, components required to understand operations and actions of a network testing system according to exemplary embodiments of the present invention will be described in detail with reference to the accompanying drawings.

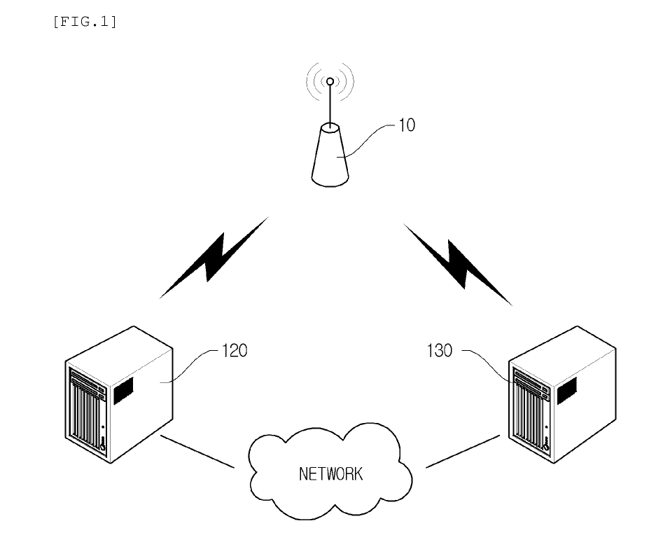

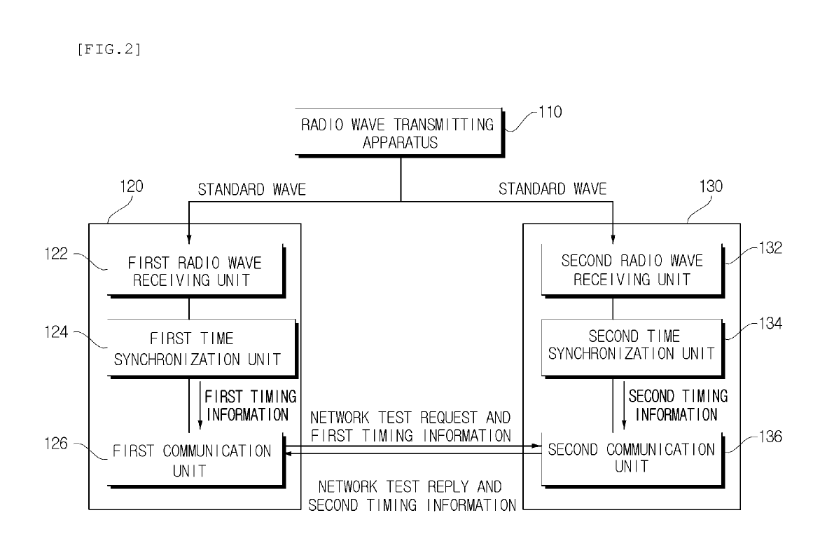

FIG. 1 is a system diagram illustrating a network testing system according to an exemplary embodiment of the present invention and FIG. 2 is a control block diagram illustrating a control configuration of the network testing system illustrated in FIG. 1.

Referring to FIGS. 1 and 2, the network testing system includes a radio wave transmitting apparatus 110 and first and second network testing apparatuses 120 and 130.

The radio wave transmitting apparatus 110 transmits a standard wave including timing data to the outside.

Herein, the standard wave means having an error due to the propagation of a very accurate frequency and being emitted as a frequency standard.

The standard wave may include timing data informing an accurate time, propagation alarm informing abnormal propagation, and the like.

In this case, the frequency of the standard wave may be at least one of 2.5, 5, 10, 15, 20, and 25 MHz, but is not limited thereto.

The first network testing apparatus 120 may include a first radio wave receiving unit 122 which receives the standard wave, a first time synchronization unit 124 which performs time synchronization based on the timing data included in the standard wave and generates first timing information, and a first communication unit 126 which transmits a network test request and the first timing information to the second network testing apparatus 130 and receives a network test reply and second timing information from the second network testing apparatus 130.

The second network testing apparatus 130 may include a second radio wave receiving unit 132 which receives the standard wave, a second time synchronization unit 134 which performs time synchronization based on the timing data included in the standard wave and generates the second timing information, and a second communication unit 136 which transmits the network test reply and the second timing information to the first network testing apparatus 130 when the network test request and the first timing information is transmitted from the first network testing apparatus 130.

The exemplary embodiment of the present invention illustrates and describes that the first and second network testing apparatuses 120 and 130 have the same configuration; however, the first and second network testing apparatuses 120 and 130 may have different configurations. Accordingly, the first and second network testing apparatuses 120 and 130 may not include at least one of the first and second communication units 126 and 136, and therefore the exemplary embodiment of the present invention is not limited thereto.

Herein, each of the first and second time synchronization units 124 and 134 may perform time synchronization based on the timing data included in the standard signal to generate the first and second timing information.

That is, each of the first and second time synchronization units 124 and 134 performs time synchronization based on the timing data included in the standard signal to considerably reduce the timing error to several ns, thereby reducing the synchronization error between the first and second network testing apparatuses 120 and 130.

Each of the first and second communication units 126 and 136 may perform wired and wireless communication with each other and may transmit and receive the network test request, the network test reply, and the like, through communication with each other.

The exemplary embodiment of the present invention describes the first network testing apparatus 120, and the second network testing apparatus 130 may be identically operated with the first network testing apparatus 120, but the exemplary embodiment of the present invention is not limited thereto.

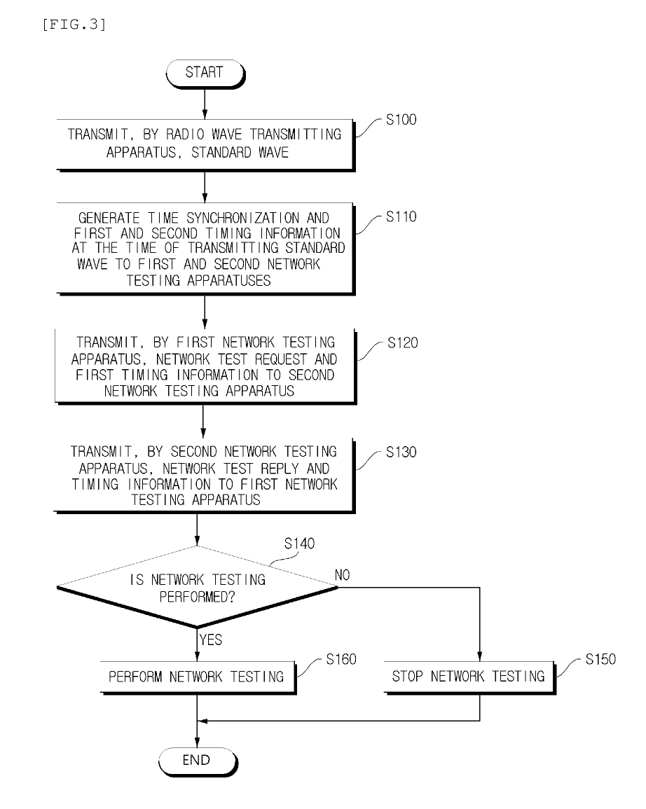

FIG. 3 is a flow chart illustrating an operating method of a network testing system according to an exemplary embodiment of the present invention.

Referring to FIG. 3, the network testing system includes transmitting, by the radio wave transmitting apparatus, the standard wave including the timing data (S100) and when the first and second network testing apparatuses transmit the standard wave, performing, by the first and second network testing apparatuses, the time synchronization based on the timing data and generating the first and second timing information (S110).

That is, the radio wave transmitting apparatus 110 transmits the standard wave including the timing data to each of the first and second network testing apparatuses 120 and 130.

The first and second network testing apparatuses 120 and 130 perform time synchronization based on the timing data at the time of receiving the standard wave and generate the first and second timing information regarding whether the time is synchronized.

The first network testing apparatus transmits the network test request and the first timing information to the second network testing apparatus (S120) and the second network testing apparatus transmits the network test reply corresponding to the network test request and the second timing information (S130).

That is, the first network testing apparatus 120 transmits the network test request and the first timing information to the second network testing apparatus 130 for network time synchronization with the second network testing apparatus 130 at a remote place.

The second network testing apparatus 130 transmits the network test reply and the second timing information regarding whether to accept the testing to the first network testing apparatus 120, based on the network test request transmitted from the first network testing apparatus 120.

The first network testing apparatus determines whether network testing is accepted and whether the time synchronization of the second network testing apparatus is performed, based on the network test reply and the second timing information transmitted from the second network testing apparatus (S140).

That is, the first network testing apparatus 120 may determine whether the network testing is performed based on the second network test reply transmitted from the second network testing apparatus 130 and may determine whether the time synchronization of the second network testing apparatus 130 is performed according to the timing data based on the second timing information.

As the determination result in step (S140), when the second network testing apparatus rejects network testing and does not perform time synchronization, the first network testing apparatus stops the network testing along with the second network testing apparatus (S150) or when the second network testing apparatus performs the network testing and completes the time synchronization, the first network testing apparatus progresses the network testing along with the second network testing apparatus (S160).

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A network testing system, comprising:
a radio wave transmitting apparatus which transmits a standard wave including timing data;
a first network testing apparatus which performs time synchronization based on the timing data at the time of receiving the standard wave and generates first timing information; and
a second network testing apparatus which performs time synchronization based on the timing data at the time of receiving the standard wave, generates second timing information, and transmits a network test reply and the second timing information for network testing at the time of receiving a network test request and the first timing information from the first network testing apparatus to perform the network testing along with the first network testing apparatus.

2. The network testing system of claim 1, wherein the first network testing apparatus includes:
a first radio wave receiving unit which receives the standard wave;
a first time synchronization unit which performs time synchronization based on the timing data and generates the first timing information; and
a first communication unit which transmits the network test request and the first timing information to the second network testing apparatus and receives the network test reply and the second timing information.

3. The network testing system of claim 1, wherein the second network testing apparatus includes:
a first radio wave receiving unit which receives the standard wave;
a second time synchronization unit which performs time synchronization based on the timing data and generates the second timing information; and
a second communication unit which receives the network test request and the first timing information from the first network testing apparatus and transmits the network test reply and the second timing information.

4. An operating method of a network testing system, comprising:
performing time synchronization based on time data and generating first timing information by a first network testing apparatus at the time of transmitting a standard wave including the timing data from a radio wave transmitting apparatus;
transmitting the first timing information and a network test request to a second network testing apparatus;
determining whether the time synchronization of the second network testing apparatus is performed, based on at least one of a network test reply and second timing information, at the time of receiving the network test reply and the second timing information corresponding to the network test request and the first timing information from the second network testing apparatus; and
as the determination result, when the timing synchronization of the second network testing apparatus is completed, performing the network testing along with the second network testing apparatus.

5. The operating method of claim 4, wherein frequency of the standard wave includes at least one frequency of 2.5, 5, 10, 15, 20, and 25 MHz having an error range.

6. The operating method of claim 4, further comprising:
as the determination result, when the time synchronization of the second network testing apparatus is not completed, stopping the network testing.
